(19) United States
(12) Patent Application Publication
(10) Pub. No.: US 2011/0231233 A1
(43) Pub. Date: Sep. 22, 2011

(54) SYSTEMS AND METHODS TO PROVIDE OFFERS TO MOBILE DEVICES IN ACCORDANCE WITH PROXIMITY-SENSITIVITY SCORES

(76) Inventors: Marianne Iannace, North Salem, NY (US); Daniel Poswolsky, Plainview, NY (US); Raffaella C. Stuart, Granite Springs, NY (US); Andrea Gilman, Chappaqua, NY (US)

(21) Appl. No.: 12/727,333

(22) Filed: Mar. 19, 2010

(51) Int. Cl. G06Q 30/00; G01C 21/00; G06Q 10/00

(52) U.S. Cl. 705/14.13; 701/300; 705/14.25

(57) ABSTRACT

According to some embodiments, a proximity-sensitivity score is determined for each of a plurality of merchants. The proximity-sensitivity scores may indicate, for example, a likelihood that potential offers from the merchants would be accepted by customers based on distances between customer locations and merchant locations. An indication of a customer's current location may be received, and a selection engine may automatically select for a customer, in substantially real time, at least one selected offer from a plurality of potential offers based at least in part on proximity-sensitivity scores and the customer's current location. Data associated with the selected offer may then be transmitted, via a wireless communication network, to a mobile device associated with the customer.

### FIELD

The present invention relates to offers that may be provided to customers via mobile devices. In particular, the present invention relates to systems and methods to provide offers to mobile devices in accordance with proximity-sensitivity scores.

### BACKGROUND

In some cases, merchants may want provide offers to customers via mobile devices. For example, a merchant might wish to give a customer a discount hoping to attract his or her attention or to reward the customer for past purchases. As used herein, a “mobile device” might refer to, for example, a wireless telephone, a Personal Digital Assistant (PDA), a mapping apparatus, or similar communication device.

Note that there may be many potential offers that could be provided to a particular customer. For example, hundreds of merchants might have offers for a particular customer, but his or her mobile device might only be able to display a limited number of offers at one time (e.g., only five offers might be simultaneously displayed on a wireless telephone). Also note that a customer might be more likely to accept some of those potential offers as compared to others. For example, a customer might be more likely to accept an offer for a free soda if he or she is relatively near the merchant who is providing the offer. Both merchants and customers may benefit when offers with higher likelihoods of acceptance are selected and displayed on mobile devices.

Moreover, merchants may influence a customer's behavior by serving promotional coupons using sophisticated behavioral-based models from robust data sources, such as models generated in connection with the use of credit and debit card accounts. Such models typically are built with the assumption that the location of a customer is static (e.g., based on his or her home address). In situations where a customer wishes to receive communications from a merchant via a mobile device, however, there might be a need to adjust typical behavioral based data to reflect the dynamic location of the customer.

It would be therefore be desirable to provide systems and methods that select appropriate offers for display on mobile devices. It would be particularly advantageous if such a system operated in a timely and accurate fashion. In addition, it may be advantageous if such a system was able to adjust typical behavioral-based models as appropriate for a mobile telephone environment.

### SUMMARY

To alleviate problems inherent in the prior art, the present invention introduces systems and methods to provide offers to mobile devices in accordance with proximity-sensitivity scores.

According to one embodiment, a proximity-sensitivity score is determined for each of a plurality of merchants. The proximity-sensitivity scores may indicate, for example, a likelihood that potential offers from the merchants would be accepted by customers based on distances between customer locations and merchant locations. An indication of a customer's current location may be received, and a selection engine may automatically select for a customer, in substantially real time, at least one selected offer from a plurality of potential offers based at least in part on proximity-sensitivity scores and the customer's current location. Data associated with the selected offer may then be transmitted, via a wireless communication network, to a mobile device associated with the customer.

Another embodiment of the present invention comprises: means for retrieving merchant information from a merchant information database; means for calculating a proximity-sensitivity score for each of a plurality of merchants based on the retrieved merchant information, wherein the proximity-sensitivity scores indicate a likelihood that potential offers from the merchants would be accepted by customers based on distances between customer locations and merchant locations; and means for storing the proximity-sensitivity scores into a proximity-sensitivity score database.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram representation of a system that may be provided according to some embodiments.

FIG. 2 is a flow chart that illustrates a method that may be performed according to some embodiments.

FIG. 3 illustrates a mobile device display in accordance with some embodiments.

FIG. 4 is a block diagram of a system according to some embodiments.

FIG. 5 is a block diagram of an offer engine according to some embodiments.

FIG. 6 is a portion of a tabular representation of a proximity-sensitivity database according to some embodiments.

FIG. 7 is a portion of a tabular representation of a ranked offer database according to some embodiments.

FIG. 8 is an illustration of a proximity-sensitivity function according to some embodiments.

FIG. 9 illustrates a system to provide offers according to some embodiments.

FIG. 10 is a block diagram of a system in accordance with one embodiment of the present invention.

FIG. 11 is a block diagram of a system in accordance with another embodiment of the present invention.

FIG. 12 illustrates a mobile device display in accordance with another embodiment.

FIG. 13 is a flow chart that illustrates a method that may be performed according to some embodiments.

### DETAILED DESCRIPTION

In some cases, merchants may wish to provide offers to customers via mobile devices. By way of example, a merchant might want to provide a customer with a discount hoping to attract his or attention or to reward the customer for past purchases. As used herein, the term “customer” might refer to, for example, a person (or entity) who executes credit or debt card transactions with merchants.

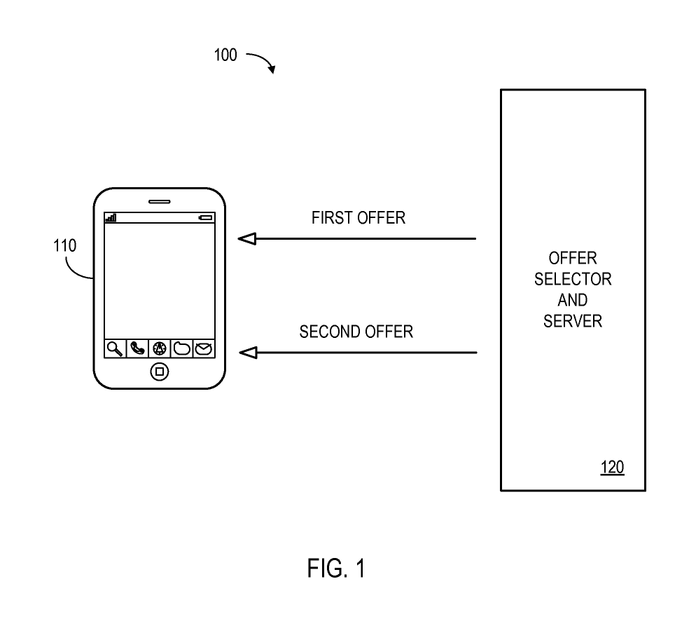

Turning now in detail to the drawings, FIG. 1 is a block diagram representation of a system 100 that may be provided according to some embodiments. The system 100 includes a customer's mobile device 110 that may receive offers from an offer selector and/or server 120. A “mobile device” might refer to a wireless telephone, a PDA, a mapping apparatus, or any similar communication device. By way of example only, the mobile device 110 might represent an iPhone®, a Blackberry®, or an apparatus associated with the Android® operating system. An “offer” might comprise, for example, text, redemption codes, images, sound, and/or video associated with a discount or any other benefit that might be provided to customers. The offer server 120 might transmit offers to the mobile device 110 via a wireless communication network, such as a third or fourth generation (3G or 4G) communication network. Although a single mobile device 110 and offer server 120 are illustrated in FIG. 1, note that any number of such devices might be included in the system 100.

Note that there may be many potential offers that could be selected by the offer server 120 to be transmitted to mobile device 110. For example, hundreds of merchants might have offers for a particular customer, but the mobile device 110 might only be able to display a limited number of offers at one time. Also note that a customer might be more likely to accept some of those potential offers as compared to others. For example, a customer might be more likely to accept an offer for a free soda if he or she is relatively near the merchant who is providing the offer. Both merchants and customers may benefit when offers with higher likelihoods of acceptance are selected by the offer server 120. It would be therefore be desirable to provide systems and methods that select appropriate offers for display on mobile devices 110. For example, the offer server 120 might decide to transmit a first offer to the mobile device 110 before a second, less attractive offer. Similarly, the offer server 120 might transmit both offers to the mobile device 110 at substantially the same time along with “ranking” values indicating that the first offer should be displayed to the customer before (or more prominently than) the second offer.

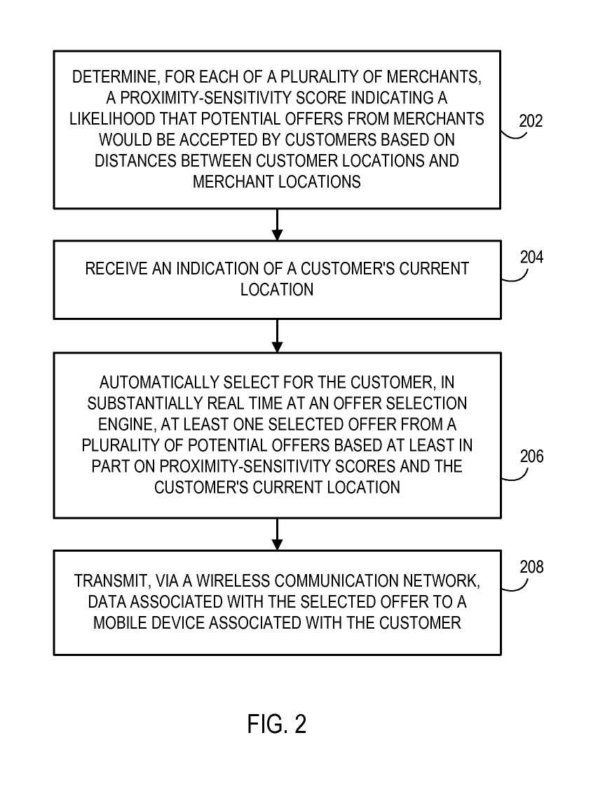

To facilitate the selection of appropriate offers, the offer server 120 may operate in accordance with any of the embodiments described herein. By way of example only, FIG. 2 is a flow chart that illustrates a method that may be performed according to some embodiments. The flow charts in FIG. 2 and the other figures described herein do not imply a fixed order to the steps, and embodiments of the present invention can be practiced in any order that is practicable. Moreover, the methods may be performed by any of the devices described herein. The method shown in FIG. 2 may be performed, for example, by offer server 120. Note that the elements of FIG. 2 and the other FIGS. described herein may be performed by different parties. For example, each element might be performed by a different party (e.g., by an issuer, an account processor, a bank, a merchant, or any other agent or party). Moreover, any single element might be performed by multiple parties.

At 202, a “proximity-sensitivity score” is determined for each of a plurality of merchants. The proximity-sensitivity score may, for example, indicate a likelihood that potential offers from the merchants would be accepted by customers based on distances between customer locations and merchant locations. For example, offers to purchase televisions at a discount might be less proximity sensitive as compared to offers to receive a free appetizer at a restaurant (e.g., because customers would be more willing to travel greater distances for larger purchases). As used herein, a “distance” between a customer location and a merchant location might represent a simple “as the crow flies” distance or a distance that takes into account available routes (e.g., streets). Note, however, that distances could also take into account an expected amount of time it would take the customer to visit the merchant (e.g., including current traffic conditions) and/or a cost associated with traveling (e.g., toll roads). As one example only, a proximity-sensitivity score could be generated for each merchant based on a ZIP code associated with the merchant's location. As will be described, a proximity-sensitivity score for a particular merchant might be based on a population density, a retailer density, publically available information about a geographic region (e.g., census information), a channel classification, a merchant category type, and/or historical shopping clusters/patterns of consumer behavior.

At 204, an indication of a customer's location is received. For example, Global Positioning Satellite (GPS) latitude and longitude information might be received from a customer's mobile device, wireless cell-phone antenna information might be received from a wireless network provider, or a customer might manually enter his or her current location (e.g., by entering a ZIP code). As still another example, a recent transaction associated with the customer might be used to determine his or her location. For example, if a customer recently purchased an item from a merchant associated with a particular geographic location, it might be inferred that the customer is currently near that location. According to some embodiments, a transaction might indicate a future location where the customer might be (e.g., he or she might purchase an airline ticket to San Jose on a particular date) and, as a result, it might be inferred that the customer will be at location on that date. In another embodiment a customer might indicate that he or she will be traveling to a particular ZIP code in the next few days and, as a result, the customer location determined at 204 may be based on that information.

At 206, at least one selected offer is automatically selected from a plurality of potential offers. For example, an offer selection engine might automatically select an offer in substantially real time based at least in part on proximity-sensitivity scores and the customer's current location. Note that the selection performed at 206 might include calculating distances between the customer and locations associated with the potential offers. For example, a first offer associated with a first merchant location five miles away from the customer's current location might be selected instead of a second offer associated with a second merchant that is four miles away from the customer if the first merchant was associated with a lower proximity-sensitivity score as compared to the second merchant. According to some embodiments, the proximity-sensitivity scores are calculated on a periodic basis (e.g., on a monthly basis) and the automatic selection of offers is performed in substantially real time.

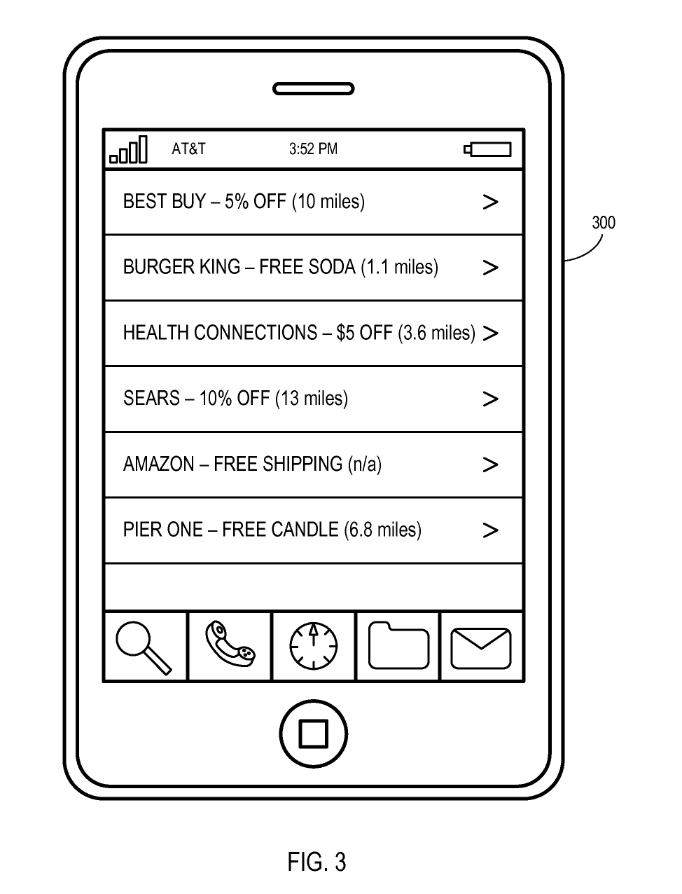

At 208, data associated with the selected offer may be transmitted, via a wireless communication network, to a mobile device associated with the customer. For example, FIG. 3 illustrates a mobile device display 300 showing six selected offers in accordance with some embodiments. According to this embodiments, the offers on the display 300 are ranked such that the ones with the highest likelihood of acceptance are displayed above those with lower likelihoods of acceptance.

Note that information in addition to the merchant proximity-sensitivity scores might be used to select offers. For example, for each of a plurality of customers, a merchant-propensity score might be determined for a plurality of merchants indicating a likelihood that potential offers from the merchants would be accepted by each customer (and the selection of offers would further based on merchant-propensity scores associated with the potential offers). The merchant-propensity score might be calculated in accordance with historical transaction information (e.g., a customer who frequently shops at a particular store might be more likely to receive offers from that store), a merchant category, a customer category, customer demographic information (e.g., younger customers might be more likely to receive offers from a particular merchant), a regression model, and/or a multivariate model.

Similarly, one or more business rules might be applied when selecting offers. For example, a business rule could be associated with a promotional payment from a merchant, prior offer results, an offer minimum, an offer maximum (e.g., an offer might be displayed to a particular customer no more than five times per week), a priority value, a day of week, a time of day, a time of month, and/or a time of year (e.g., an offer from a swimwear store might be less likely to be accepted in the winter).

Moreover, the selection of offers could further be based on customer preference information applied to the potential offers. For example, the customer preference information might be associated with general customer preference information (e.g., he or she might indicate that sporting equipment is of particular interest), and/or current customer preference information received from the customer in substantially real time (e.g., a customer might indicate that he or she is currently looking for a restaurant).

Those skilled in the art will recognize that the various factors associated with the selection of offers could be combined and/or calculated in any number of different ways. By way of example only, an offer server might calculate, for each of the potential offers, a location adjusted score f(0) using the equation:

$$f ( 0 ) = {\sum }_{i = 1}^{i = 5} {w}_{i} f ( i )$$

where f(1) is associated with proximity-sensitivity scores, f(2) is associated with distances, f(3) is associated with merchant-propensity scores, f(4) is associated with business rule values, f(5) is associated with customer preference values, and w₁ through w₅ comprise pre-determined and/or function specific weight values. According to some embodiments, any of the factors described herein might also function as a weight value. For example, a proximity-sensitivity score might act as a weight value to be multiplied with a current distance between a customer and a merchant associated with an offer.

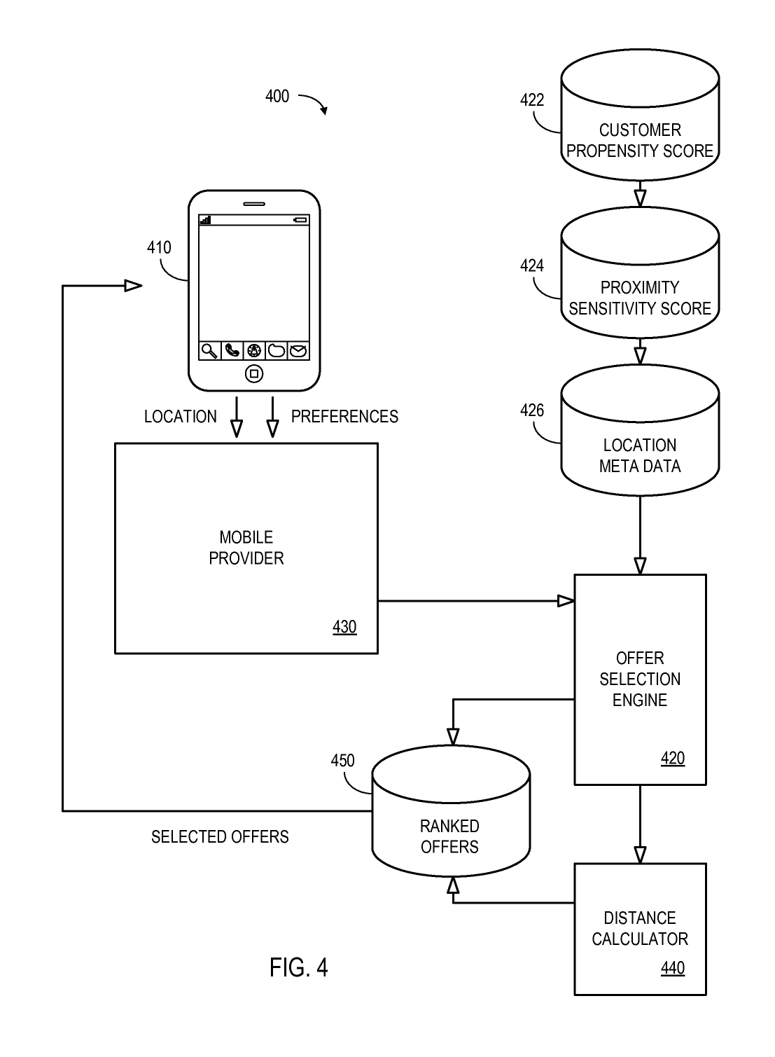

The selection of offers for a mobile device 410 might be performed, for example, by an offer selection engine 420 in a system 400 such as the one illustrated in FIG. 4. Note that, as, as used herein, devices may communicate, for example, via a communication network 130 such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a cable television network, or an Internet Protocol (IP) network such as the Internet, an intranet or an extranet. Moreover, as used herein, communications include those enabled by wired or wireless technology. Although a single mobile device 410 and offer selection engine 420 are shown in FIG. 4, any number of such devices and networks may be included in the system 400. Similarly, any number of the other devices described herein may be included in the system 400 and/or be combined in single devices according to embodiments of the present invention.

The offer selection 410 may receive customer propensity scores 422 (e.g., indicating how likely a particular customer is to accept an offer from a particular merchant), proximity-sensitivity scores 424 (e.g., indicating how location-sensitive customers are to each merchant), and location meta data 426 (e.g., rule-based knowledge). Some or all of this information might be “staged” (e.g., calculated in non-real time). Moreover, the customer propensity scores 422 might be stored based on credit or debit account numbers, and the proximity-sensitivity scores 424 might be stored based on merchant identifiers.

The offer selection engine 420 might also receive customer location and/or preference information from the mobile device 410 via a mobile provider 430. For example, the customer might enter in a current ZIP code along with an indication that he or she is interested in purchasing books. The offer selection 420 might then use a distance calculator 440 to determine how for the customer is from a number of potential offers (e.g., merchant locations associated with those offers). The offer selection may then rank the offers based on the distances, the proximity-sensitivity scores 424, and other relevant information and store the ranked results ion a ranked offer database 450. The ranked offers may then be transmitted to the mobile device 410.

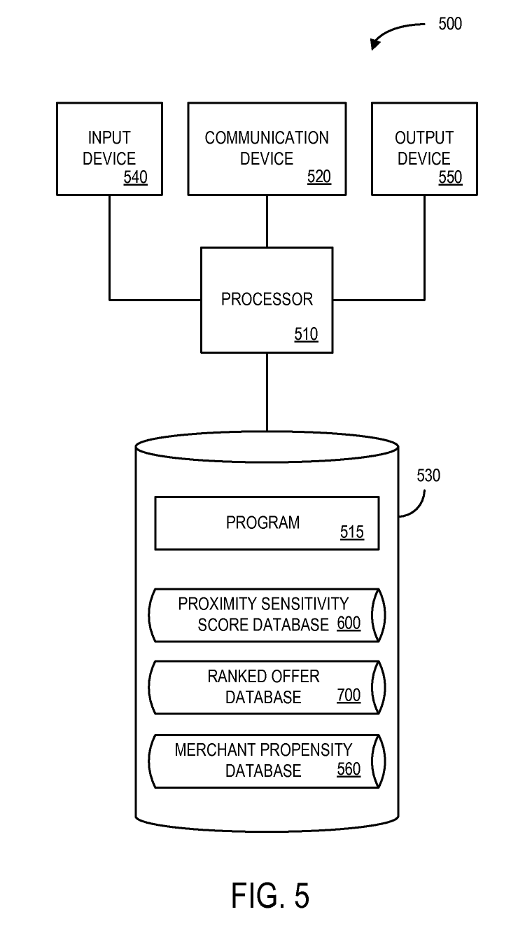

FIG. 5 is a block diagram of an offer engine 500 that might be descriptive of the devices shown in FIGS. 1 and/or 4 according to an embodiment of the present invention. The engine 500 comprises a processor 510, such as one or more INTEL® Pentium® processors, coupled to a communication device 520 configured to communicate via a communication network (not shown in FIG. 5). The communication device 520 may be used to communicate, for example, with mobile devices and/or providers.

The processor 510 may also be in communication with a local input device 540. The local input device may comprise, for example, a keyboard, a mouse or other pointing device, a switch, an infrared port, a docking station, and/or a touch screen. Such a local input device 540 may be used, for example, to provide rules and threshold values associated with offers. The processor 510 may also be in communication with a local output device 550. The local output device 550 may comprise, for example, a display (e.g., a computer monitor), a speaker, and/or a printer. The local output device may be used, for example, to generate reports and/or export information to be provided to merchants.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 stores a program 515 for controlling the processor 510. The program 515 may be stored in a compressed, uncompiled and/or encrypted format. The program 515 may furthermore include other program elements, such as an operating system, a database management system, and/or device drivers used by the processor 510 to interface with peripheral devices.

The processor 510 performs instructions of the program 515, and thereby operates in accordance with the present invention. For example, the processor 510 may determine a proximity-sensitivity score is determined for each of a plurality of merchants. The proximity-sensitivity scores may indicate, for example, a likelihood that potential offers from the merchants would be accepted by customers based on distances between customer locations and merchant locations. An indication of a customer's current location may be received by the processor 510, and at least one selected offer may be selected from a plurality of potential offers, in substantially real time, based at least in part on proximity-sensitivity scores and the customer's current location. Data associated with the selected offer may then be transmitted, via communication device 520, to a mobile device associated with the customer.

As used herein, information may be “received” by or “transmitted” to, for example: (i) the engine 500 from remote device; or (ii) a software application or module within the engine 500 from another software application, module, or any other source.

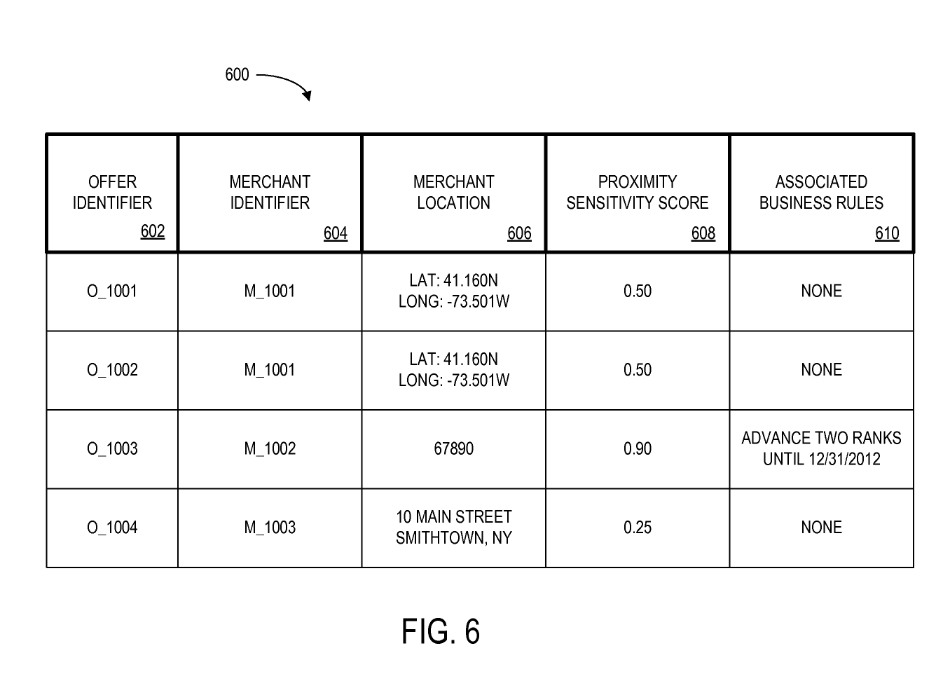

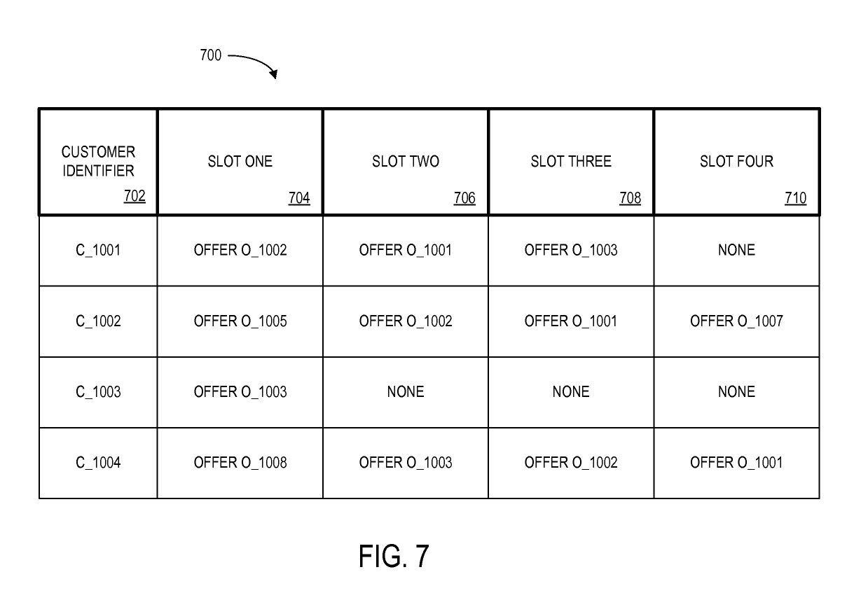

As shown in FIG. 5, the storage device 530 also stores a proximity-sensitivity score database 600 (described with respect to FIG. 6), a ranked offer database 700 (described with respect to FIG. 7), and a merchant propensity database 560. Examples of databases that may be used in connection with the engine 500 will now be described in detail with respect to FIGS. 6 and 7.

Note that the illustrations and accompanying descriptions of the databases 600, 700 presented herein are exemplary, and any number of other database arrangements could be employed besides those suggested by the figures. For example, as will be understood by those skilled in the art, the schematic illustrations shown herein and the following descriptions of the exemplary entries are merely examples of arrangements for stored representations of information. Any number of other arrangements may be employed besides that suggested by the tables shown. Similarly, the illustrated entries of the databases represent exemplary information only.

In a practical embodiment, the number of entries in the various databases may be in the thousands, or even in the millions. Moreover, for convenience of presentation, some databases are shown as having only five fields. However, in practice additional fields may be present, such as other fields for additional merchant or offer information, etc. Moreover, the various databases may generally be integrated with other databases used for other purposes in addition to those described herein. Also, note that the information stored in the databases 600, 700 may be stored by (or at) and/or accessed by any number of different parties or locations (e.g., by an issuer, an account processor, a bank, and/or any other agent or party).

FIG. 6 is a portion of a tabular representation of a proximity-sensitivity database 600 that may be stored at the engine 500 according to an embodiment of the present invention. The table includes entries identifying merchants. The table also defines fields 602, 604, 606, 608, 610 for each of the entries. The fields specify: an offer identifier 602, a merchant identifier 604, a merchant location 606, proximity-sensitivity score 608, and associated business rules 610. The information in the proximity-sensitivity database 600 may be created and updated, for example, based on information received from merchants and/or modeling engines. Some or all of the information in the customer database 600 may also be based on, for example, public information, such as census data.

The offer identifier 602 may be, for example, an alphanumeric code associated with a particular offer and the merchant identifier 604 might be an alphanumeric code identifying the merchant who is providing that offer. The merchant location 606 might represent a physical location associated with the merchant (e.g., a particular retail establishment). The merchant location 606 might represent, for example, latitude and longitude coordinates, a ZIP code, an area code, and/or a street address. The proximity-sensitivity score 608 might be, for example, a value between zero and one indicating a likelihood that potential offers from each merchant would be accepted by customers based on distances between customer locations and merchant locations. The associated business rules 610 might represent one or more rules or functions that should be considered when potential offers are being selected for a customer.

FIG. 7 is a portion of a tabular representation of a ranked offer database 700 that may be stored at the engine 500 according to an embodiment of the present invention. The table includes entries identifying customers. The table also defines fields 702, 704, 706, 708, 710 for each of the customers. The fields specify: a customer identifier 702 and four offer slots 704, 706, 708, 710. The information in the ranked offer database 700 may be created and updated, for example, based on current customer locations and proximity-sensitivity scores 608 associated with each offer (and/or merchant).

The customer identifier 702 may be, for example, an alphanumeric code associated with a particular customer (e.g., a credit or debit card account number). The slots 704, 706, 708, 710 may represent a rank list of offers that have been selected for that customer. According to some embodiments, each eligible customer or account will have a location-adjusted score applied for every eligible offer. The database 700 may be constructed whereby if there are “n” accounts, and “m” offers, the resulting table has “n”×“m” rows. The table may sorted by account and descending location-adjusted score. Note that a customer may receive offers based upon the location-adjusted score, such that the order of offer delivery is based upon the highest score or scores, depending upon the number of offers a mobile device application may deliver.

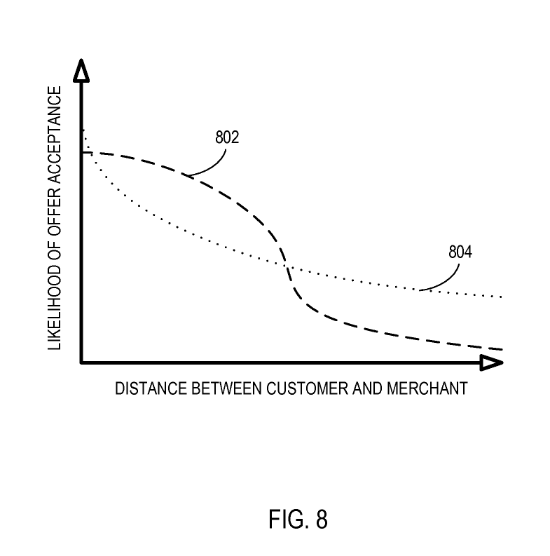

As illustrated in FIG. 6, a proximity-sensitivity score might comprise a single value. According to other embodiments, a proximity-sensitivity score might comprise multiple values (e.g., a first value for when the customer is within 1 mile of a merchant location and another value for when he or she is farther away). According to still other embodiments, a proximity-sensitivity score comprises a function. For example, FIG. 8 is an illustration of two proximity-sensitivity functions 802, 804 according to some embodiments.

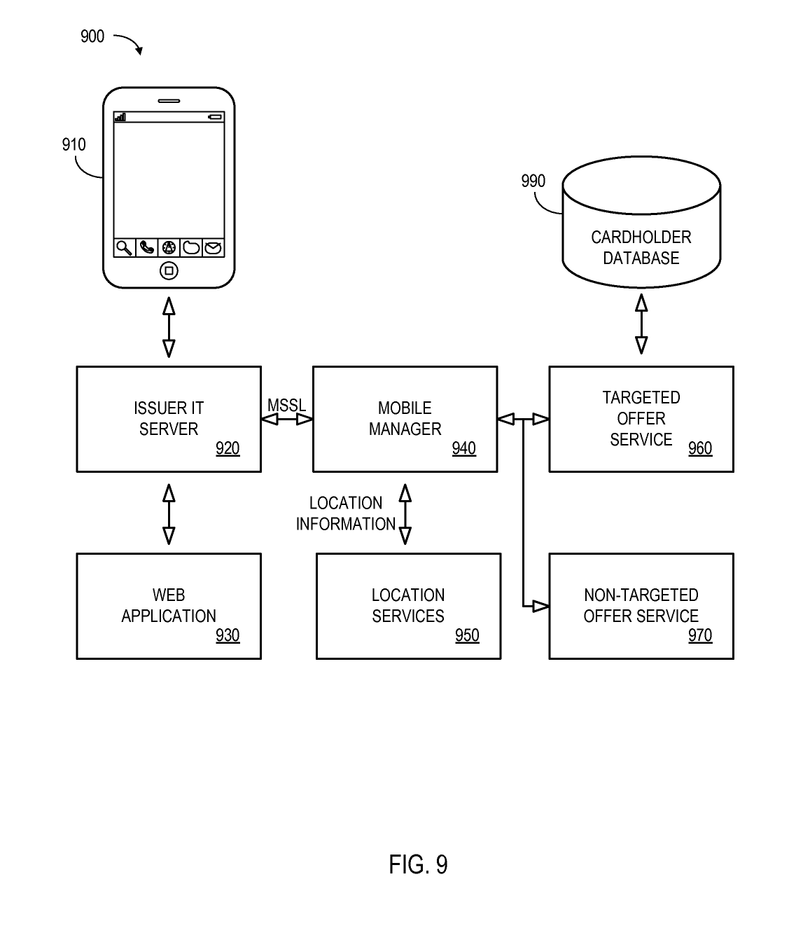

According to some embodiments, a mobile offer selection engine includes a service interface for vendors and/or issuing banks to access a targeted offer program. For example, FIG. 9 illustrates a system 900 to provide offers to a mobile device 910 according to some embodiments. In particular, a mobile manager 940 might communicate with the mobile device 910 and with web applications 930 via a Mutual Secure Sockets Layer (MSSL) protocol and an issuer Information Technology (IT) server 920. The web applications 930 might, for example, allow customers to access offer information via a web site or provide access to the mobile manager 940 for a system administrator and/or merchants.

According to some embodiments, the system 900 may utilize an open Application Programming Interface (API) such that offers may be delivered to different types of mobile devices 910 (e.g., via a downloadable application, a mobile-friendly web site, short message service data, multimedia message service data, and/or email content). Moreover, the mobile online manager 940 might support a targeted offer service 960 (e.g., targeted based on information in a cardholder database 990) and a non-targeted offer service 970. The mobile manager 940 might also provide location based offers (e.g., in accordance with at least one of street addresses, latitude/longitude values, or ZIP codes received from location services 950) and/or category based offers (e.g., sports or dining).

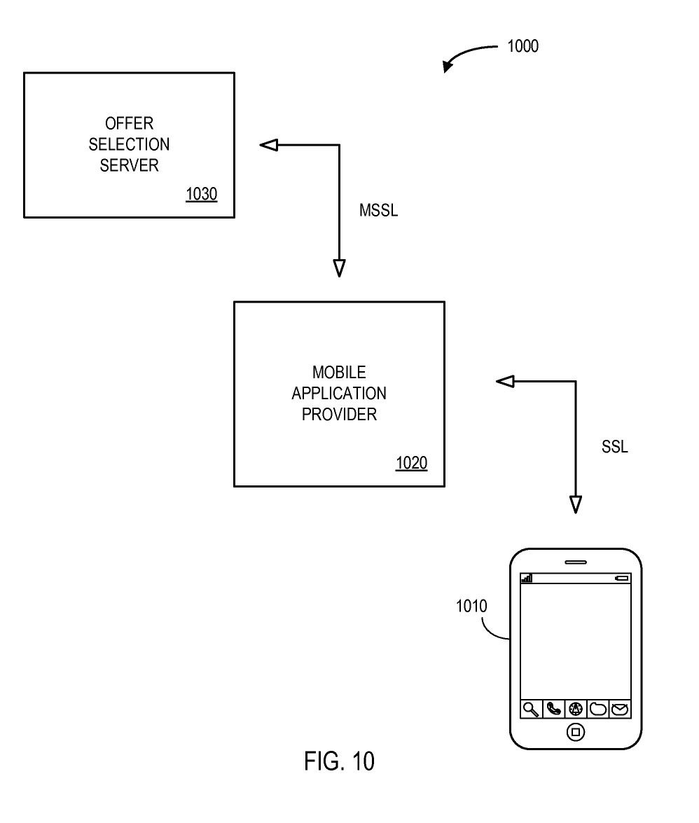

FIG. 10 is a block diagram of a system 1000 in accordance with one embodiment of the present invention. In particular, a mobile device 1010 exchanges SSL data from a mobile application provider 1020 which in turn exchanges MSSL data from an offer selection server 1030. In some cases, an application executing at the mobile device 1010 will transmit a request to the mobile application provider 1020, including a user name, telephone number, a location, and/or a user preference. The mobile application provider 1020 may then map the received information to a credit or debit card account number and forward the request to the offer selection server 1030. The offer selection server 1030 selects offers in accordance with any of the embodiments described herein and the offer data is provided in a reply to the original request.

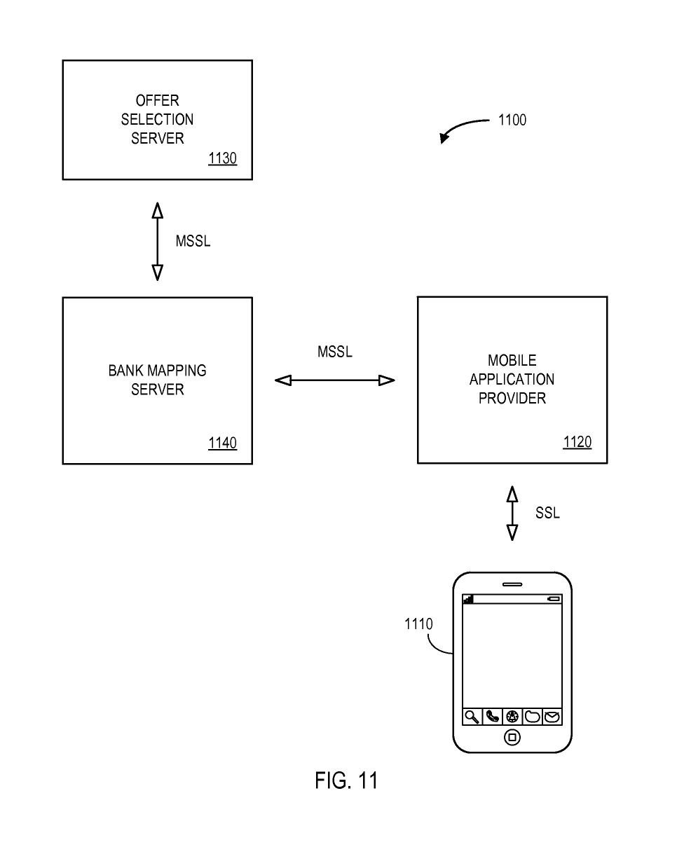

FIG. 11 is a block diagram of a system 1100 in accordance with another embodiment of the present invention. In this example, a mobile device 1110 exchanges SSL data from a mobile application provider 1120 which in turn exchanges MSSL data from an offer selection server 1130. In this embodiment, however, the mobile application provider 1120 and offer selection server 1130 communicate via a bank mapping server 1140. As before, an application executing at the mobile device 1110 may transmit a request to the mobile application provider 1120, including a user name, telephone number, a location, and/or a user preference. The mobile application provider 1120 may forward the request to the offer selection server 1130 via the bank mapping server (e.g., which may, for example, may the request to a credit or debit card account number). The offer selection server 1130 selects offers in accordance with any of the embodiments described herein and the offer data is provided in a reply to the original request.

In either embodiment, the request issued by the mobile device might be transmitted using the Extendable Markup Language (XML) protocol. For example, a request might include:

<request>

<application>mobileoffer</application>
<method>getOffers</method>
<version>1.0</ version>
<locale>en_US</ locale>
<payload>

<offersCriteria>

<count/>
</count>
<category>

<id>sports</id>
<id>Adventure</id>

</category>
<user>

<id />

</user>
<location>

<postalCode />
<latitude />
<longitude />

</location>
<attributes/>

</offersCriteria>

</payload>

</request>

In this case, the payload element consists of the actual request, and the child elements might include a count (e.g., the desired number of offers to return), and the categories of offers. The category element may contain zero or more category identifiers to be returned. If none is specified, offers from any category might be returned. Examples of “categories” might include: adventure; airlines, car and rail; car rental; cruises; hotels and resorts; travel services; dining and entertainment; food and gourmet; gifts and shopping; ground transportation; lifestyle and recreation; news and periodicals; personal services; retail; sports; toys and novelty items; journeys and adventures; education and learning; and improvement and wholesale stores.

The location might comprise a zero or one location element. The postalCode may be used to search relative to a zip/postal code. The system may also specify latitude and longitude to search relative to a specific latitude/longitude coordinate.

The attributes may determine what offer attributes the client requires to be returned in the response. It may take the form of a comma-separated list of attribute type names of the form [ParentElement]ChildElement. Response will return only those attributes declared in the filter. For example, to query just the offer title and the merchant name, the value would look like: title,Merchant,[Merchant]name. Attributes might be used to customize for different device and/or screen sized (e.g., short or long descriptions and high or low resolution images).

The response received by the mobile device may also be expressed in XML. For example, a response might include:

<response>
<payload>

<offersList type=“0”>

<Offers depth=“2” total=“3”>

<Offer id=“115258”>

<Merchant ref=“107501”>

<name>Merchant Name</name>

</Merchant>
<endDate>20111031000000</endDate>
<Location ref=“107502”>

<state>Missouri</state>
<city>Ofallon</city>

</Location>
<Category ref=“107484”>
</Category>
<Category ref=“92668”>

<name>Car and Rail</name>

</Category>
<Category ref=“92669”>

<name>Hotels and Resorts</name>

</Category>
<title>10% Off</title>
<startDate>20091229000000</startDate>
<detailedDescriptionGet 10% off at Merchant on

following items</detailedDescription>

</Offer>
Offer id=“115259”>

<endDate>20111031000000</endDate>
<Merchant ref=“107501”>

<name> Merchant Name</name>

</Merchant>
<Category ref=“107484”>
</Category>
<Location ref=“107502”>

<state>Missouri</state>
<city>Ofallon</city>

</Location>
<detailedDescription>Get 5% off at Merchant on

following items</detailedDescription>

<Category ref=“92668”>

<name>Car and Rail</name>

</Category>
<Category ref=“92669”>

<name>Hotels and Resorts</name>

</Category>
<title> 5% Off</title>
<startDate>20091217000000</startDate>

</Offer>

</Offers>

</offersList>
<offersList type=“1”/>

</payload>
</response>

The payload content might contain, for example, an offer id for each offer. Each offers element may contain some number of Offer elements, corresponding to the total attribute, and may contain the attributes for one offer (e.g., merchant name, phone number, web site, street address, latitude and longitude, terms and conditions, offer title, offer date, image, and/or redemption code). Thus, merchant offers may be served on a mobile device (e.g., via a mobile friendly website, a mobile application, or an SMS protocol) to targeted customers based on the location-adjusted propensity scores. Moreover, each cardholder may initially be assigned a merchant propensity score that indicates his or her likelihood to shop at a specific merchant or category. This score may be calculated, for example, based on the customer's historical transaction data, customer supplied preferences, a customer home address, and/or other potential demographic information.

Independent of the merchant propensity score, each offer or merchant may be assigned a proximity-sensitivity score. For example, a restaurant offer may have a higher proximity-sensitivity score as compared to an electronics offer.

A distance factor may also be calculated (e.g., on a real-time basis). Using GPS latitude and longitude location of the mobile device and/or a manually entered location from the customer, the distance from the customer's current location to the locations where he or she can redeem each offer may be automatically calculated. Other factors, such as a category preference factor (e.g., customized by the customer prior to or at the time of the offer inquiry) and business rules may be applied in substantially real-time as the customer interacts with an application executing at the mobile device.

The location-adjusted propensity score may then be calculated for each customer/offer combination based upon the propensity score, proximity-sensitivity score, distance factor, category preference factor, and/or business rules. The customer may then, according to some embodiments, receive offers ranked by location-adjusted propensity scores.

According to some embodiments, some or all of the scores are derived from historical credit or debit card transactions. Advanced time-series data structures may identify thousands of derived time series variables per account, which may provide information across various industries, seasons, times-of-day, geographies, spending velocities, purchase affinities, and/or relative associations of these values.

The merchant propensity score may indicate a customer's likelihood to shop at a specific merchant and/or within a particular category. This score may be calculated based on the customer's transaction data, preferences, home address, and/or other potential demographic information. According to some embodiments, a targeting sample may be developed by defining a group of like cardholders, such as issuer cardholders eligible for the mobile service. The cardholders either may or may not have engaged with the target merchant/category during a given time period. The transaction behaviors in that time period, as well as additional data (e.g., offer preferences) may be provided by the customer. Note that the target may be developed from transaction behavior by the cardholder in another time period. The target may be, for example, a binary indicator of activity in the target or may be a continuous value associated with the target (e.g., an amount of spending in target). The target may be channel specific and defined by merchant locations.

A proximity-sensitivity score may be an independent factor representing a behavioral likelihood of shopping at a particular location based upon proximity to that merchant location. Factors might include a channel classification, a category type, a population density, and/or historical shopping clusters. According to some embodiments, customer preferences may be factored into the final location adjusted propensity score in substantially real time via a separate step.

As used herein, a “channel classification” might indicate that a merchant is classified as brick-n-mortar, catalog, on-line, or non-store retail. The channels in which the mobile device user shops will inform the proximity-sensitivity score to the extent that proximity matters. For example, catalog and on-line channels may not be affected by location at all, while brick-n-mortar merchants may be highly affected.

The “category type” of merchant may be based upon an industry classification whereby each category has varying sensitivity factors. For available offers, the corresponding merchant category type may be identified. The category and/or merchant may also play a role in the development of the proximity-sensitivity score. For example, offers within the travel category may not be as location sensitive as a restaurant offer.

The proximity-sensitivity score may also be influenced by population density (e.g., as available in U.S. census statistics). Based upon U.S. census data, for example, each ZIP code may be assigned a population density ranking. The ranking may then be used when calculating the proximity-sensitivity score for the merchant (e.g., such that accounts are more sensitive to the proximity of the merchant in more densely populated areas). For example, a customer might be willing to travel ten miles to a merchant in a rural setting, but less than a mile in urban settings.

A historical shopping cluster may show correlations between willingness/distance to travel between consecutive purchases within a finite time period for a given ZIP code, category, merchant, and/or channel. The data to develop impact models from a residential ZIP code location to the merchant location may be readily available. Note that purchase patterns around a given merchant may indicate a proxy for the variable location, and subsequently factor into the proximity-sensitivity score.

A distance factor may be calculated in real time. According to some embodiments, a customer latitude and longitude may be identified based on where he or she is standing, walking, or driving with their mobile device. In other embodiments, a customer may input a location (e.g., a street address or ZIP code) in which he/she desires merchant offers. The system may then automatically calculate distances from the customer's location to the locations where they can redeem each offer. The distance may be, for example, a numeric value that will be applied within the location-adjusted score algorithm. In the event that no distance can be calculated, a default value might be returned.

According to some embodiments, the distance factor might further take into account a velocity and/or direction of a customer movement. For example, if a customer is driving north on a highway, offers associated with merchant locations to the south of the customer may be less likely to be accepted. According to other embodiments, altitude information may be considered within the distance factor (e.g. when the customer is at a multi-level shopping mall).

A customer preference offer factor might let the customer provide a preference in real time about his or her preferred offer categories. For example, the customer might select or enter a category to indicate an offer preference. A factor may then be calculated based upon the preference input in conjunction with the category.

A business rules factor may incorporate additional rules or logic. For example, it might apply to the distribution of offers such as minimum amounts, maximum amounts, quotas, and/or merchant prioritization.

According to some embodiments, a location-adjusted propensity score for each offer may be calculated based on the merchant propensity score, the proximity-sensitivity score, the distance factor (from the customer's location to the closest merchant location), a customer preference offer factors, and/or business rules. The scoring algorithm could simply be a function, where f(0) is the location-adjusted score:

f(0)=f(1)+f(2)+f(3)+f(4)+f(5).

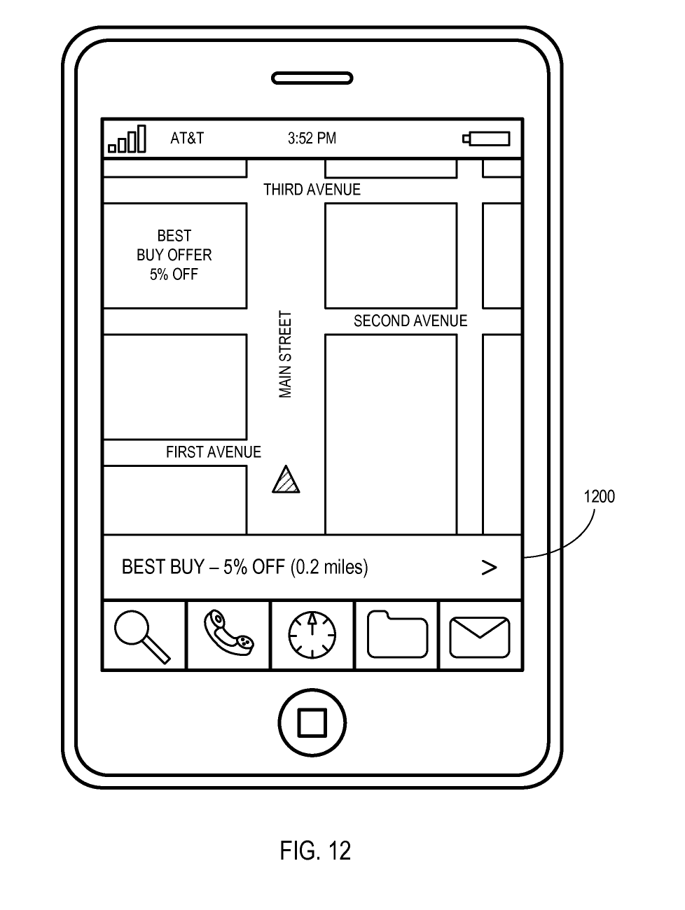

Although particular offer descriptions have been provided herein as example, note that offers might be presented on a mobile device in any number of ways. For example, instead of the list of offers illustrated in FIG. 3, only a single offer might be provided to a user at any given time. FIG. 12 illustrates a mobile device display 1200 in accordance with another embodiment. Note that location-specific offer information might also be provided on the display (e.g., on a map displayed to the customer).

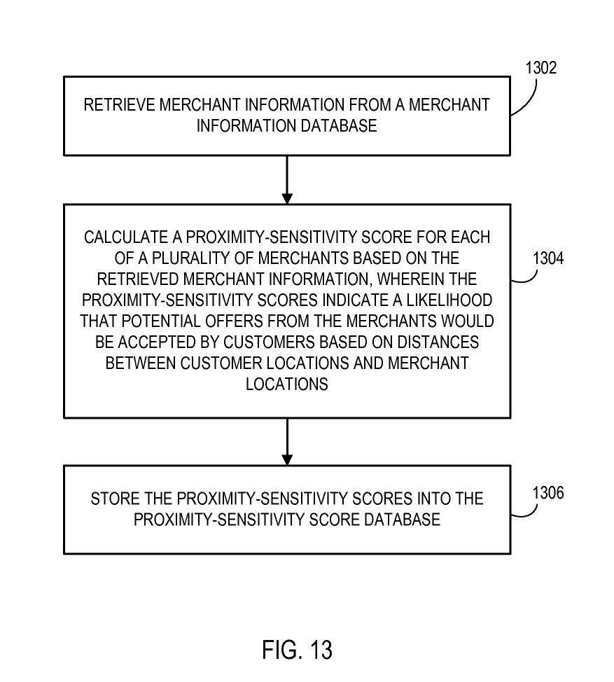

Note that proximity-sensitivity scores and/or merchant preference scores may be generated using modeling techniques. For example, FIG. 13 is a flow chart that illustrates a method that may be performed according to some embodiments. At 1302, merchant information is retrieved from a merchant information database. For example, a ZIP code, street address, or latitude/longitude coordinates associated with a merchant store location might be retrieved. A proximity-sensitivity score may then be calculated at 1304 for each of a plurality of merchants based on the retrieved merchant information. The proximity-sensitivity scores may indicate a likelihood that potential offers from the merchants would be accepted by customers based on distances between customer locations and merchant locations. The proximity-sensitivity scores might be based on a merchant channel classification including at least one of: (i) a physical retailer channel, (ii) an online channel, (iii) a catalog channel, or (iv) a non-store retail channel. The proximity-sensitivity score might also be based at least in part on a category type associated with each merchant and/or population density information associated with each merchant's location. According to some embodiments, the proximity-sensitivity score is further based on historical transaction clusters identified within a transaction history database and/or the customer's (and/or other customers) acceptance of previous offers in view of their location. At 1306, the proximity-sensitivity scores may be stored into a proximity-sensitivity score database (e.g., for later use when potential offers are being selected).

Similarly, a merchant propensity score may be developed using transaction spending information and/or modeling techniques. According to some embodiments, when developing a model, independent variables may be constructed from transaction spending information. Diagnostic tests may be calculated and variables may be selected for inclusion in a model to predict likelihood of being in the target via the variable reduction process. The final model may be a logistic regression, linear regression model, or a non-linear multivariate model depending on the approach and best-fitting solution.

Model performance evaluation could involve dividing the population into sub-groups (typically into deciles based on predicted score values), comparing the impact of targeting groups based on “predicted scores” vs. “no model” in capturing “actual” effect within the targeted group, for example, model lift, and comparing “actual” behavior across groups—to assess if groups with higher “predicted” scores demonstrate higher levels of the “actual” effect.

In some embodiments, customers may be scored based upon their actual spending behaviors relative to summarized information for the prior months of spending activity of all associated independent variables. Accounts may be scored and ranked, and a cut-off score may be applied to select the top scoring merchant look-a-likes. Across all offers, merchant scores may be normalized such that rankings are comparative and competitive across offers. The scores may be stored in a database and used to select offers to be provided to customers via mobile devices.

Thus, embodiments of the present invention may improve the offers that are selected and presented to customers. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
determining, for each of a plurality of merchants, a proximity-sensitivity score indicating a likelihood that potential offers from the merchants would be accepted by customers based on distances between customer locations and merchant locations;
receiving an indication of a customer's current location;
automatically selecting for the customer, in substantially real time at an offer selection engine, at least one selected offer from a plurality of potential offers based at least in part on proximity-sensitivity scores and the customer's current location; and
providing data associated with the selected offer to be transmitted, via a wireless communication network, a mobile device associated with the customer.

2. The method of claim 1, wherein said selecting includes:
calculating distances between the customer and locations associated with the potential offers, and said selecting is based on the calculated distances.

3. The method of claim 2, further comprising:
determining, for each of a plurality of customers, a merchant-propensity score for a plurality of merchants indicating a likelihood that potential offers from the merchants would be accepted by each customer,
wherein said selecting is further based on merchant-propensity scores associated with the potential offers.

4. The method of claim 3, wherein the merchant-propensity score is calculated in accordance with at least one of: (i) historical transaction information, (ii) a merchant category, (iii) a customer category, (iv) customer demographic information, (v) a regression model, or (vi) a multivariate model.

5. The method of claim 3, wherein the proximity-sensitivity scores are calculated on a periodic basis and said automatic selection is performed in substantially real time.

6. The method of claim 5, wherein the proximity-sensitivity score is associated with at least one of: (i) a ZIP code, (ii) a population density, (iii) a retailer density, (iv) census information, (v) a channel classification, (vi) a merchant category type, or (vii) historical shopping clusters.

7. The method of claim 5, wherein said selecting is further based on at least one business rule applied to the potential offers.

8. The method of claim 7, wherein the business rule is associated with at least one of: (i) a promotional payment, (ii) prior offer results, (iii) an offer minimum, (iv) an offer maximum, (v) a priority value, (vi) a day of week, (vii) a time of day, (viii) a time of month, or (ix) a time of year.

9. The method of claim 7, wherein said selecting is further based on customer preference information applied to the potential offers.

10. The method of claim 9, wherein the customer preference information is associated with at least one of: (i) general customer preference information, (ii) current customer preference information, (iii) customer transaction data received from a batch process, or (iv) customer transaction data received in substantially real time.

11. The method of claim 9, wherein said selecting comprises:
calculating, for each of the potential offers, a location adjusted score f(0) using the equation:
$$f ( 0 ) = {\sum }_{i = 1}^{i = 5} {w}_{i} f ( i )$$
wherein:
f(1) is associated with proximity-sensitivity scores,
f(2) is associated with distances between customers current locations and locations associated with potential offers,
f(3) is associated with merchant-propensity scores,
f(4) is associated with business rule values,
f(5) is associated with customer preference values, and w₁ through w₅ comprise function specific weight values.

12. The method of claim 11, wherein at least one function specific weight value is determined at least in part on the proximity-sensitivity score.

13. The method of claim 1, wherein the indication of the customer's current location is associated with at least one of: (i) global positioning satellite system information, (ii) mobile device tracking information, (iii) a user input, or (iv) a recent transaction associated with the customer.

14. The method of claim 1, wherein said transmitting is associated with at least one of: (i) a downloadable application executing at the mobile device, (ii) a web site adapted to interact with the customer via the mobile device, (iii) short message service data, (iv) multimedia message service data, or (v) email content.

15. An apparatus, comprising:
a merchant information database;
proximity-sensitivity score database;
a modeling engine processor; and
a storage device in communication with said modeling engine processor and storing instructions adapted to be executed by said processor to:
retrieve merchant information from the merchant information database,
calculate a proximity-sensitivity score for each of a plurality of merchants based on the retrieved merchant information, wherein the proximity-sensitivity scores indicate a likelihood that potential offers from the merchants would be accepted by customers based on distances between customer locations and merchant locations, and
store the proximity-sensitivity scores into the proximity-sensitivity score database.

16. The apparatus of claim 15, wherein the proximity-sensitivity score is based at least in part on a merchant channel classification including at least one of: (i) a physical retailer channel, (ii) an online channel, (iii) a catalog channel, or (iv) a non-store retail channel.

17. The apparatus of claim 16, wherein the proximity-sensitivity score is further based at least in part on a category type associated with each merchant.

18. The apparatus of claim 17, wherein the proximity-sensitivity score is further based on population density information associated with each merchant's location.

19. The apparatus of claim 17, further comprising:
a transaction history database, wherein the proximity-sensitivity score is further based on historical transaction clusters identified within the transaction history database.

20. A computer-readable medium storing instructions adapted to be executed by a computer processor to perform a method of presenting a selected offer to a customer, said method comprising:
determining, for each of a plurality of merchants, a proximity-sensitivity score indicating a likelihood that potential offers from the merchants would be accepted by customers based on distances between customer locations and merchant locations;
receiving an indication of the customer's current location;
automatically selecting for the customer, in substantially real time at an offer selection engine, the selected offer from a plurality of potential offers based at least in part on proximity-sensitivity scores and the customer's current location; and
providing data associated with the selected offer to be transmitted, via a wireless communication network, a mobile device associated with the customer.

21. The computer-readable medium of claim 20, wherein said selecting includes:
ranking a plurality of selected offers to be transmitted to the mobile device associated with the customer.

22. The computer-readable medium of claim 20, wherein said selecting includes:
calculating, for each of the potential offers, a location adjusted score f(0) using the equation:
$$f ( 0 ) = {\sum }_{i = 1}^{i = 5} {w}_{i} f ( i )$$
wherein:
f(1) is associated with proximity-sensitivity scores,
f(2) is associated with distances between the customer's current location and locations associated with the potential offers,
f(3) is associated with merchant-propensity scores,
f(4) is associated with business rule values,
f(5) is associated with customer preference values, and w₁ through w₅ comprise function specific weight values.

23. The computer-readable medium of claim 22, wherein at least one function specific weight value is determined at least in part on the proximity-sensitivity score.

24. The computer-readable medium of claim 20, wherein said transmitting is associated with at least one of: (i) a downloadable application executing at the mobile device, (ii) a web site adapted to interact with the customer via the mobile device, (iii) short message service data, (iv) multimedia message service data, or (v) email content.
